(19) United States
(12) Patent Application Publication
(10) Pub. No.: US 2005/0277452 A1
(43) Pub. Date: Dec. 15, 2005

(54) Mobile phone carrying case

(76) Inventor: Apple Grace Pasamba, Guttenburg, NJ (US)

Correspondence Address: Robert L. Slater;Slater & Cole, LLP, Suite 1101, 11 Broadway, New York, NY, 10004, US

(21) Appl. No.: 10/856,621

(22) Filed: May 28, 2004

(51) Int. Cl. H04M 1/00

(52) U.S. Cl. 455/575.6

(57) ABSTRACT

A carrying case attaching conventional personal mobile phone instruments on to the forearm or wrist of the phone's user in a manner that permits the mobile phone to be utilized while fastened there is disclosed. The carrying case provides improved security for the mobile phone instrument and greater convenience and reduced risk of loss for mobile users. In particular, the carrying case permits operation of mobile phones for sending and receiving calls without removing the mobile phones from the carrying case and without removing the carrying case from the user's arm. The carrying case includes an arm band that attaches the carrying case to the user's wrist or forearm and a retainer that is affixed to the arm band at one end and removably attached to the arm band at the other end. The retainer is flexible and transparent so that users can actuate switches through the retainer, permitting one-handed use of the mobile phone. A cover layer is provided over the retainer that camouflages the mobile phone as an item of apparel. The cover layer also secures the lids of clam shell phones when the phones are not in use. Miniature personal mobile phones are mounted transversely for improved display screen legibility and user access to the mobile phone's keypad.

### BACKGROUND OF THE INVENTION

The invention is directed to a mobile phone carrying case. More particularly, the invention is directed to a device for protecting personal mobile phones from becoming lost and for making utilization of personal mobile phones more convenient.

Mobile wireless telephones, in the form of personal communications devices that are carried by both men and women wherever they may go, have now become commonplace in public spaces. These personal mobile phones customarily include a display screen and are small enough to be carried in one's pocket or in a handbag. Personal mobile phones have also been provided with a small, custom-fitted protective carrying case or case in which the phone instrument may be secured. Most presently available carrying cases are also furnished with a clip that attaches the carrying case to the user's waist belt.

To operate these personal mobile phones, the users usually need to observe their phone's screen for receiving incoming information during a call and for monitoring outgoing information during dialing. Upon receipt and acceptance of an incoming call, and after dialing an outgoing call, the mobile phone is then held in the user's hand near to the side of the user's face while the user listens to and speaks into the phone.

When a personal mobile phone is carried by the user in a pocket or purse or by means of one of the aforementioned personal mobile phone carrying cases, the person using the phone must first retrieve the phone from its concealed position in a garment pocket, or purse, or from a carrying case on the user's belt. Once the personal mobile phone is retrieved, it is held in a first position one of the person's hands, while the person actuates selected key switches on the phone with the other hand for dialing the phone, and while the person monitors the display screen. The personal mobile phone is also held by the person in either hand and raised to a second position near to one of the person's ears, being held there in that hand as long as the person is using the phone for listening and speaking. Following completion of the call, the personal mobile phone is usually returned to a purse, to a garment pocket or to a belt-mounted carrying case. However, in the above-described mobile phone handling operations, before being safely returned to the carrying case, the purse, or the pocket, these personal mobile phones frequently become misplaced or otherwise separated from their owners. Personal mobile phones are very frequently lost and misplaced.

Still another troublesome feature of these personal mobile phones is that they are ill-suited to being carried by women, given that women's suits, dresses and other garments frequently lack pockets that are appropriate to retain and comfortably carry a mobile phone. Also, women's apparel often lacks a waist belt that is sufficiently sturdy to support the aforementioned carrying cases without causing either damage to the belt or discomfort to the wearer, or both.

Accordingly, there is need for a more secure and more convenient means for carrying and utilizing personal mobile phones.

### SUMMARY OF THE INVENTION

A personal mobile phone carrying case in accordance with the invention includes a wrist band that permits the mobile phone to be securely and comfortably attached to a person's arm. My improved phone carrying case includes an elongated flexible transparent retainer attached at one end to the wrist band. The transparency of the retainer enables a user to use the phone's keypad switches while the phone is attached by the retainer to the carrying case that is attached to user's arm. The flexibility of the retainer enables a user to dial outgoing calls and control other functions of their personal mobile phone by actuating switches without removing the phone from this carrying case.

In accordance with my invention, while the mobile phone is secured in the novel mobile phone carrying case and the carrying case is attached to a person's wrist or forearm, the mobile phone may be raised to a position near to the person's ear. Thus, that person need not remove that phone from its secure place in the carrying case to listen to and speak into the phone in accordance with the present invention.

Furthermore, my improved personal mobile phone carrying case provides for convenient operation of keypad and function control switches on the mobile phone without removing the phone from its carrying case.

### BRIEF DESCRIPTION OF THE FIGURES

The features and advantages of the invention will be better understood when the description of presently preferred embodiments given below is considered in conjunction with the figures provided, wherein:

FIG. 1 is a perspective view of a mobile phone secured within a carrying case that is mounted on a person's wrist in accordance with a first embodiment of my invention;

FIG. 2 is a cross section view of the embodiment of the invention shown in FIG. 1, taken at the plane designated as 2-2;

FIG. 3 is a detail view of one of the keypad switches shown in FIG. 2 showing the switch being depressed by the user;

FIG. 4 is a view of the inner side of the wrist band and the retainer of the carrying case shown in FIG. 1;

FIG. 5 is a perspective view of the carrying case of FIG. 1 in which a mobile phone that is different from the mobile phone of FIG. 1 is shown in place of the mobile phone shown in FIG. 1;

FIG. 6 shows a second embodiment of the carrying case of my invention;

FIG. 7 is a perspective view of a third embodiment of the carrying case of my invention; and

FIG. 8 is a perspective view of a third embodiment of the carrying case shown in FIG. 7 in which a mobile phone that is different from the mobile phone of FIG. 7 is shown in place of the mobile phone shown in FIG. 7.

In these figures similar structures have like reference numerals.

### DETAILED DESCRIPTION OF MY INVENTION

FIG. 1 shows a conventional personal mobile phone 10 that is mounted within a novel mobile phone carrying case 12 that is constructed and mounted on a user's arm 14 in accordance with a first presently preferred embodiment of my invention. The novel mobile phone carrying case 12 shown in FIG. 1 is strapped to a forearm area on the arm of the mobile phone user 14. My novel mobile phone carrying case 12 includes an elongated transparent retainer 16 and an arm band 18 which holds the carrying case 12 in place on the forearm or wrist of the mobile phone user 14.

In accordance with the invention, the mobile phone 10 is adjustably secured by the flexible transparent retainer 16 to the arm band 18 while mounted in the mobile phone carrying case 12, so that many of the personal mobile phones that are available to consumers—personal mobile phones that have different formats and different user interface designs—can be secured in the user's carrying case 12. The flexible retainer 16 that extends across the keypad switches of the mobile phone 10 are actuated by the user. Thus, the phone's keypad switches 20 are visible through the retainer 16, as illustrated in FIG. 1. Preferably, the personal mobile phone is positioned in the carrying case with the ten keypad switches 20 that are used to dial outgoing calls located on the side of the mobile phone 10 that is opposite to the side of the mobile phone that is in contact with the arm band 18, so that the keypad is supported by the user's arm when the keypad switches are actuated by the user, as shown in FIG. 3.

The personal mobile phone 10 also has function keys 20a, a display screen 22, a speaker 24 and a microphone 26. In the unitary mobile phone format of this particular personal mobile phone 10, all elements of the user interface: the keypad switches 20, the function key switches 20a, the screen 22, the speaker 24 and the microphone 26, are located on the same side of the mobile phone 10. Mobile phone designs vary widely, but the screen 22 and the keypad switches 20 are usually located so that they are visible on the same side of the phone 10 while calls are being sent and received. On the other hand, the speakers 24 and microphones 26, in particular, are found in various locations on the surface of personal mobile phones 10, because mobile phone speakers and microphones can perform satisfactorily so long as they are held near to the side of the user's face. Thus, for example, the speaker 24 and microphone 26 may be located on the side or back surfaces of the mobile phone. However, mobile phone carrying cases 12 constructed and mounted on the user's arm in accordance with my invention are suitable for use with such alternative mobile phone designs.

The arm band 18 is preferably made of a flexible porous material, such as a woven fabric or a non-woven polymer or leather material having apertures that permit evaporation of moisture from the skin covered by the arm band 18. For example, the particular arm band 18 shown in FIG. 1 is a woven nylon strap. This strap 18 has an inner face 28 and an outer face 30. The inner face 28 is applied to the surface of the wrist or forearm of the user 14, as seen in FIG. 1. The inner face 28 of this strap 18 near the distal end of a first portion 32 of the strap 18 has a hook-and-loop fastener strip 34a, for instance a pad of Velcro™ loop-fiber material. The outer face 30 of this strap 18 near the distal end of a second portion 36 of the strap 18 is furnished with a complementary hook-and-loop fastener strip 34b, for instance a pad of Velcro™ hook-fiber material. Thus, when the strap 18 is wrapped about the user's wrist or forearm, the strap 18 may be securely fastened by juxtaposing and engaging the hook-and-loop fastener strips 34a, 34b.

The transparent retainer 16 shown in FIG. 1 is a rectangular strip of a transparent flexible polymer sheet material having a first portion 40 and a second portion 42. The first portion 40 of the transparent retainer 16 is fixedly attached to the outer face 30 of the strap 18 shown in FIG. 1 with eyelets or grommets 46 at a suitable distance from the distal end of a first portion 32 of the arm band 18. Other means of fixedly attaching the transparent retainer 16 to the arm band 18 are contemplated, including applying adhesives to that particular area 40 on the transparent retainer 16 and the arm band 18, or forming the transparent retainer 16 or the arm band 18, or both, from a thermal polymer material that is suitable for welding the two together by applying heat to that area of the retainer 16 and the arm band 18, or forming the retainer 16 as an integral part of the arm band 18.

The transparent retainer 16 has an outer face 50 and an inner face 52. A hook-and-loop fastener strip 54a is attached to the inner face 52 of the transparent retainer 16 at the distal end 42 thereof A complementary hook-and-loop fastener strip 54b is attached to the outer face 30 of the strap 18 on the corresponding second portion 36 of the arm band 18. Thus, the user's personal mobile phone 10, 10a, is securely fastened to the arm band 18 using the transparent retainer 16 by engaging the hook material of the hook-and-loop fastener strip 54a on the retainer 16 with the loop material of the hook-and-loop fastener strip 54b on the arm band 18 at a location on that strip of loop material 54b that provides tension on the retainer 16 so that pressure and friction provided by the retainer 16 holds the mobile phone 10 tightly against the arm band 18.

Once a mobile phone 10 is attached to the user's wrist or forearm 14, the display screen 22, and control switches for mobile phone functions 20a needed for incoming and outgoing calls are available for one-handed operation by the user. The phone is then raised to the user's ear to in the carrying case 12, to talk and listen during a call while the carrying case 12 is still attached to the user's arm 14. Users extend their forearms 14 to move the phone 10 to a position that is convenient for reading the screen 22, dialing phone numbers by pressing keypad switches 20 through the flexible transparent retainer 16, and controlling other mobile phone features by actuating the corresponding function switches 20a.

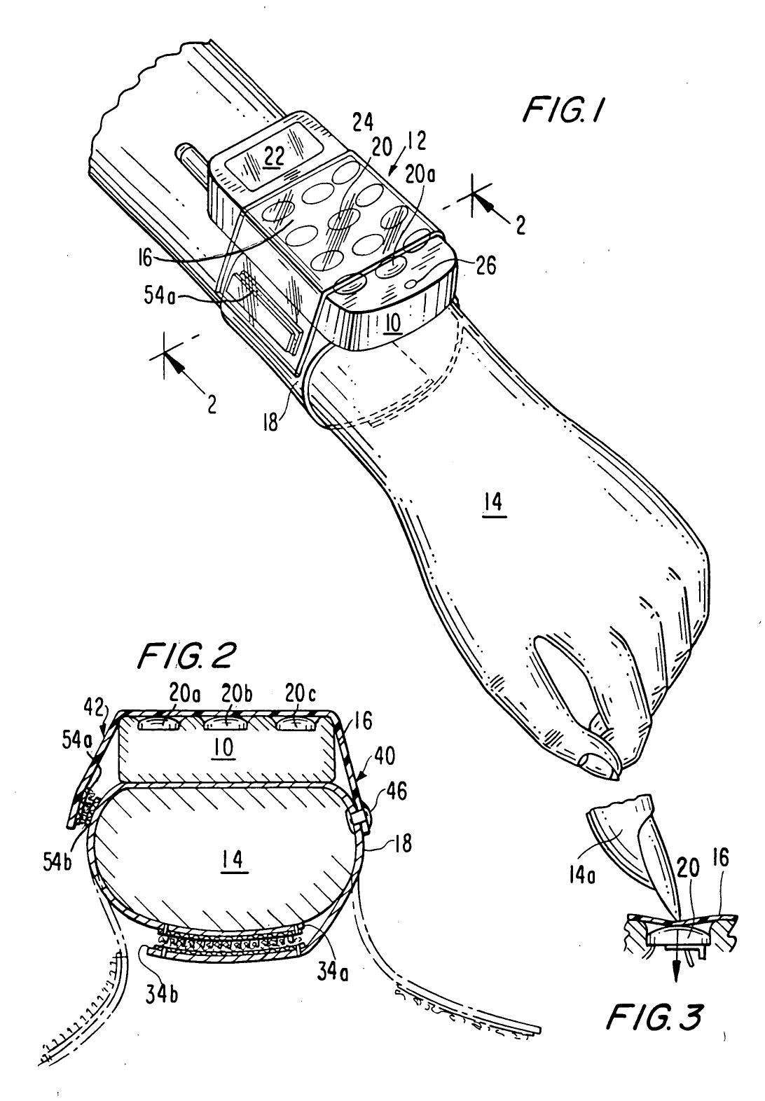

FIG. 2 is a cross section view of FIG. 1 at the plane designated 2-2. The cross section in FIG. 2 shows three keypad switches 20 that are covered by the transparent retainer 16.

FIG. 3 is a detail view of the personal mobile phone 10 and carrying case 12 of FIGS. 1 and 2, showing a keypad switch being operated by the user's fingertip 14a while the mobile phone 10 is held in the carrying case 12 by the transparent retainer 16 in accordance with my invention.

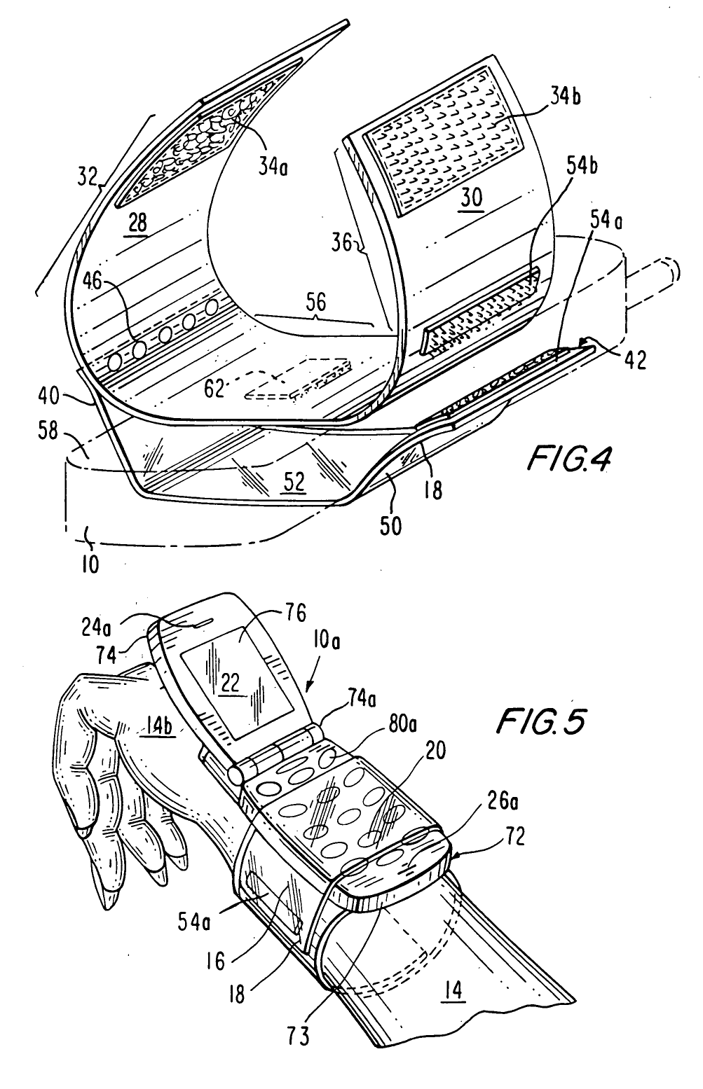

FIG. 4 shows the inside faces of the retainer 16 and the arm band 18 shown in FIG. 1. The hook-and-loop fastener strips 34a, 34b, and 54a, 54b, are shown separated, ready to secure a mobile phone (shown in phantom) to the arm band 18 and to secure the arm band 18 to the user's wrist or forearm. To secure a mobile phone to the outside face of the arm band shown in FIG. 4, the personal mobile phone 10 is preferably positioned on the arm band 18 and then tightly bound to the arm band 18 by covering at least some of the keypad switches 20 with the transparent retainer 16 and then juxtaposing and engaging the hook-and-loop fastener strips 54a, 54b. This is preferably done before attaching the arm band 18 to the user, so that both hands can be used when initially positioning the mobile phone.

After securing the mobile phone 10 to the arm band 18, the arm band 18 can then be conveniently placed on the wrist or forearm of the user 14, juxtaposing and engaging the hook-and-loop fastener strips 34a, 34b, with one hand. In general it is easier for a person to fasten the arm band 18 with one hand than it is for the person to position and secure a mobile phone on that person's arm using only one hand. However, because the transparent retainer 16 is fixedly attached to the arm band 18 at one end, the tension provided by the engagement of the hook-and-loop fastener strips 54a, 54b, fastening the transparent retainer 16, as well as the hook-and-loop fastener strips 34a, 34b, fastening the arm band 18, can be readily changed at any time for the comfort of the user, and also to adjust the mobile phone 10 under the arm band 18, as discussed further below with reference to clam shell mobile phones 10a.

In addition to securing the mobile phone 10 to the arm band 18 using the transparent retainer 16, one or more complementary hook-and-loop fastener strips 54c may be affixed to a center portion 56 of the outer face 30 of the arm band 18 and to the back panel 58 of the phone 10. When this hook-and-loop fastener strip 54c on the center portion 56 of the arm band 18 is juxtaposed and engaged with such a hook-and-loop fastener strip (not shown) affixed to the back panel 58 of the mobile phone 10, the mobile phone 10 is then secured directly to the arm band 18 in addition to being secured indirectly to the arm band 18 by the transparent retainer 16. Any other of the suitable removable attachment means that are well-known in the art—such as a hook and loop friction clip—may be used.

Although the retainer 16 is also wrapped firmly around the mobile phone 10, in the event of an accidental impact or a rapid change in acceleration during vigorous movement of the user's arm, this additional attachment further reduces the risk that one of the heavier mobile phone instruments 10 will slip out from under the transparent retainer 16 of my wrist carrying case 12. Advantageously, the carrying case is constructed so that loop material that is integral with the carrying case is provided in the location shown as a hook-and-loop fastener strip 54c in FIG. 4, so that the user can optionally either attach a strip or strips of hook material to their mobile phone, or use no hook material, if their phone does not require such additional attachment means.

FIG. 5 shows the embodiment of my novel mobile phone carrying case 12 shown in FIGS. 1-4 used to secure a hinged “clam shell” format mobile phone 10a to a user's arm 14, in the wrist area of the arm 14. The clam shell mobile phone 10a is comprised of a phone base 72 and a hinged phone lid 74. The phone's hinged lid 74 of the clam shell phone 10a includes a display screen 22a and a speaker 24a. In order to use a clam shell mobile phone 10a it is necessary to open the phone's hinged lid 74 which exposes the key switches 20, function switches 20a and the microphone 26a.

When using a mobile phone 10a having the clam shell format, the transparent retainer 16 may be momentarily loosened to allow the user to slide the mobile phone 10 along the user's arm out from under the retainer 16 far enough to be able to open the phone's hinged lid 74, as shown in FIG. 5. The phone is then re-secured to the user's arm with its lid 74 open, as shown in FIG. 5, by tightening the retainer 16 over the phone's base 72, as shown. When the call is completed the transparent retainer 16 may again be loosened to permit the user to close and lock the phone's hinged lid 74 by sliding the phone case out from under the transparent retainer 16 so that phone's lid 74 can be opened by the user, before the user slides the phone 10a back under the retainer 16 and re-tightening the transparent retainer 16.

Alternatively, the flexible transparent retainer 16 may be made of a thin sheet of flexible transparent material that is thin enough to remain between the lid 74 and the base 72 when the clam shell is closed. This alternate retainer does not have to be loosened when the mobile phone is used, so the phone can be answered faster and remains secure while the clam shell is opened and shut.

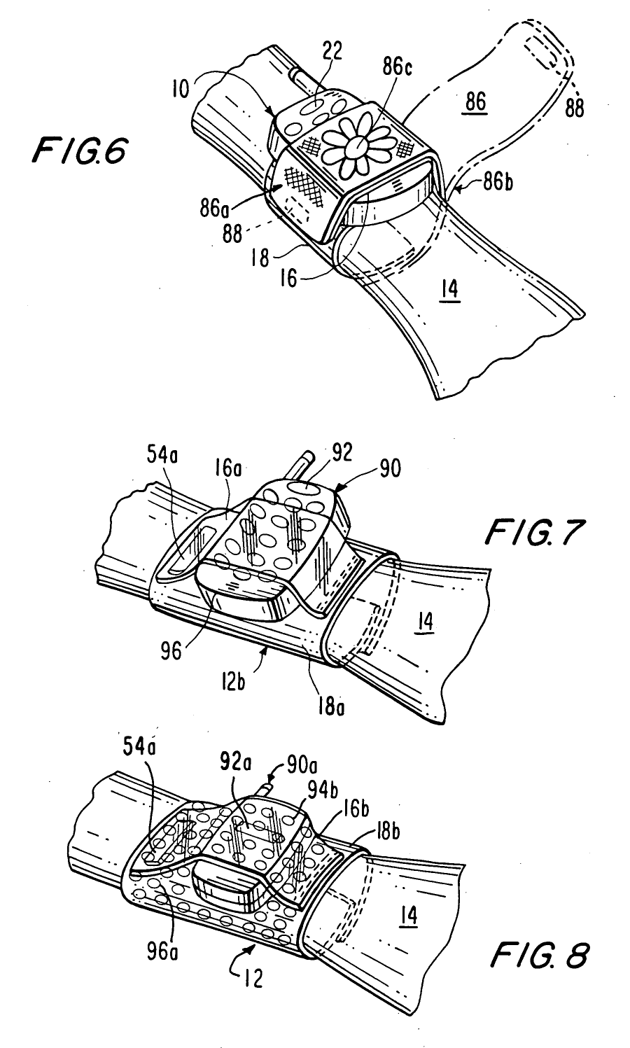

FIG. 6 shows a second embodiment of my invention. The retainer 16 and arm band 18 on this carrying case 12a are substantially the same as those described above with reference to the embodiment shown in FIG. 1. However, to camouflage the mobile phone as an apparel item while the mobile phone 10 is not in use, a decorative cover layer 86 is attached to the retainer 16 so that the decorative cover layer 86 covers at least a portion of the keypad switches 20 that are covered by the flexible transparent retainer 16.

The decorative cover layer 86 shown in FIG. 6 is removably attached to the transparent retainer 16 at one end 86a of the decorative layer 86 using strips of complementary hook-and-loop fastener materials 88 that are attached to the outer face 50 of the retainer 16 and to the decorative cover layer 86, or by other suitable attachment means that are well known in the art. The other end of this decorative cover layer 86b may be fixedly attached to the transparent retainer 16 by a welded seam (not shown), or other fixed attachment means that are well known in the art, so that the decorative cover layer 86 can be moved aside while the keyboard switches 20 are used, thereby preventing loss of the decorative cover layer 86. Furthermore, when the retainer 16 is located between the base 72 and the lid 74 of a closed clam shell mobile phone 10a, this decorative cover layer 86 is adapted to cover the lid of the clam shell phone 10a to camouflage the phone 10a as an apparel item, as described above. However, the cover layer 86 also prevents the lid 74 from becoming damaged because it accidentally fell open. Without this cover layer 86 the lid may be inadvertently opened by rapid movement of the user's arm 14 or, when the clam shell phone 10a is mounted with the hinge 74a nearest to the user's hand 14b for convenience in reading the display screen 22a, simply by the force of gravity. Alternatively the two ends of the decorative cover layer 86 may be attached directly to the arm band 18 on one or both ends of the retainer 16 so that the mobile phone 10, 10a is more completely camouflaged.

However, both ends of the decorative layer 86a, 86b, may also advantageously be attached to the transparent retainer 16 (or to the arm band 18) by respective strips of hook-and-loop fastener material 88, or other removable fastener means that are well known in the art, so that alternative decorative layers 86 having different design styles may be attached to the mobile phone carrying case 12a and then conveniently changed by the user whenever desired. For example, a decorative layer 86 having a more conservative design style that is more suitable for business apparel, a simple opaque cover for instance, may be substituted for the decorative layer 86 shown in FIG. 6 that includes a three-dimensional silk flower 86c.

The features and formats provided by personal mobile phones are continually evolving. In particular, personal mobile phones are becoming increasingly smaller and more compact. FIGS. 7 and 8 show two variants of a third embodiment of the mobile phone carrying case 12b, 12c, suitable for use with these smaller mobile phones 90, 90a. The respective ends 40, 42, of the respective transparent retainers 16a, 16b, are fixedly and removably attached as described above with reference to the first embodiment shown in FIG. 1.

In FIGS. 7 and 8, these miniaturized mobile phones 90, 90a, are mounted on respective arm bands 18a, 18b, transverse to the length of the user's arm 14 in accordance with this third embodiment of my invention, so that the vertical axis of characters printed or displayed on the mobile phone is parallel to the length of the user's arm 14. Mounting a miniaturized mobile phone 90, 90a transverse to the length of the user's arm 14 makes the miniature screen 92 and miniature keypad 94 provided by these instruments 90, 90a more legible and more readily accessible to the user. Therefore, this third embodiment 12b, 12c, of my invention is particularly advantageous for use with miniature phones 90, 90a, in that it makes the utilization of miniaturized personal mobile phones 90, 90a more convenient for the mobile phone user 14.

Also, the particular transparent retainers 16a, 16b, and straps 18a, 18b, shown in FIGS. 7-8 are made of a non-woven porous material. The miniature clam shell mobile phone 90a has a caller-I.D. window 92a that is visible through the transparent retainer 16b. Also, the transparent retainer 16b and strap 18b, shown in FIG. 8 are both perforated by die-cut apertures 96, 96a. The apertures 96 in the strap 18b increase the user's comfort when the carrying case is worn in hot environments, by increasing the ventilation provided by the non-woven material of the strap 18b. A cover layer (not shown) may also be provided to cover all or part of these retainers 16a, 16b, as described above with reference to the decorative cover layer 86, shown in FIG. 6.

The invention has been described with particular reference to particular presently preferred embodiments, however it will be apparent to one skilled in the art that variations and modifications thereto are possible within the spirit and scope of this invention. The invention is defined by the following claims.

1. Apparatus for carrying a mobile phone having a plurality of keypad switches, said apparatus comprising:
an arm band;
a flexible transparent retainer having a first end and a second end, said retainer being adapted to extend across at least some keypad switches on a mobile;
first attachment means for fixedly attaching said first end of said flexible transparent retainer to said arm band, and
second attachment means for removably attaching said second end of said flexible transparent retainer to said arm band.

2. The apparatus of claim 1 wherein said arm band is a porous woven strap.

3. The apparatus of claim 1 wherein said arm band is a porous non-woven strap.

4. The apparatus of claim 3 wherein said porous non-woven strap includes perforations.

5. The apparatus of claim 1 wherein said flexible transparent retainer includes perforations.

6. The apparatus of claim 1 wherein the back side of the mobile phone includes attachment means affixed thereto, said apparatus further comprising third attachment means on said arm band for removably attaching the mobile phone to said arm band in cooperation with the attachment means affixed to the backside of the mobile phone.

7. The apparatus of claim 1 further comprising a decorative cover layer having first and second ends, said first end being adapted to be removably attached to said flexible transparent retainer so that said decorative cover layer covers at least a portion of the keypad switches covered by said retainer and said decorative cover layer can be moved aside to permit use of keypad switches covered by said retainer.

8. The apparatus of claim 7 wherein both ends said decorative layer are removably attached to said transparent retainer, so that said decorative cover layer is interchangeable with other decorative cover layers.

9. The apparatus of claim 7 wherein the mobile phone is a clam shell mobile phone having a lid, and wherein an end of said decorative cover layer is fixedly attached to said transparent retainer and said decorative cover layer is adapted to secure the lid of the clamshell mobile phone.

10. The apparatus of claim 7 wherein the mobile phone is a clam shell mobile phone having a lid, and wherein said second end of said decorative cover layer is fixedly attached to said flexible transparent retainer and said decorative cover layer is adapted to secure the lid of the clamshell mobile phone.

11. The apparatus of claim 1 further comprising a decorative cover layer having first and second ends, said first end being adapted to be removably attached to said arm band so that said decorative cover layer covers at least said portion of the keypad switches covered by said transparent retainer and said decorative cover layer can be moved aside to permit use of keypad switches covered by said retainer.

12. The apparatus of claim 11 wherein both ends of said decorative layer are removably attached to said arm band, so that said decorative cover layer is interchangeable with other decorative cover layers.

13. The apparatus of claim 11 wherein the mobile phone is a clam shell mobile phone having a lid, and wherein said second end of said decorative cover layer is fixedly attached to said arm band and said decorative cover layer is adapted to secure the lid of the clamshell mobile phone.

13. The apparatus of claim 1 wherein said retainer is adapted to mount the mobile phone parallel to the length of the user's arm.

14. The apparatus of claim 1 wherein said retainer is adapted to mount the mobile phone transverse to the length of the user's arm.

15. Apparatus for carrying a mobile phone, said apparatus comprising:
an arm band having a first end and a second end, said first and second ends having respective first and second attachment means for removably attaching said first and second ends to each other;
an elongated, flexible, transparent retainer having a first end and a second end;
third attachment means for fixedly attaching said first end of said elongated, flexible transparent retainer to respective portions of said arm band, and
fourth attachment means for removably attaching said second end of said elongated, flexible transparent retainer to said arm band.

16. The apparatus of claim 15 wherein one of said first and second attachment means, and one of said third and fourth attachment means are a hook material of a hook-and-loop fastener and the other is a loop material of a hook-and-loop fastener.
